(19) United States
(12) Patent Application Publication
(10) Pub. No.: US 2026/0081492 A1
(43) Pub. Date: Mar. 19, 2026

(54) LAMINATION SCALLOP AND SHAFT KNURL

(71) Applicant: BorgWarner Inc., Auburn Hills, MI (US)

(72) Inventors: Ryan Jones, Markleville, IN (US); Jesse Hendrickson, Cicero, IN (US); Jason Ryan, Noblesville, IN (US); Stephen Grollimund, Middletown, IN (US)

(21) Appl. No.: 19/326,855

(22) Filed: Sep. 12, 2025

Related U.S. Application Data
(60) Provisional application No. 63/694,505, filed on Sep. 13, 2024.

(51) Int. Cl. H02K 1/28; H02K 1/276; H02K 7/00

(52) U.S. Cl. CPC H02K 1/28; H02K 1/276; H02K 7/003

(57) ABSTRACT

An electric machine includes a rotor press fit to a knurled section of a shaft. The rotor includes a lamination stack having multiple laminations. Each lamination includes a disc defining a center hole. Slots defined in the disc. Each slot is configured to receive a magnet at least partially defining a magnetic pole of the electric machine. The center hole has a circumference including a number of scallops. Each scallop intrudes into the disc. A stator is disposed radially outward of a rotor.

### CROSS REFERENCE TO RELATED APPLICATIONS

This application claims the benefit of an earlier filing date from U.S. Provisional Application Ser. No. 63/694,505 filed Sep. 13, 2024, the entire disclosure of which is incorporated herein by reference.

### BACKGROUND OF THE INVENTION

In fields where rotor construction is undertaken, such as for alternators, motors, and similar electric machines, it is common to press a rotor shaft into a set of laminations (referred to as a lamination stack) to produce a completed rotor. One such electric machine is a traction motor, commonly used for propulsion systems.

Rotors have been constructed in this way for many years and are commercially acceptable. However, it is also the case that the pressing operation can introduce compression, distortion, cupping and gaps within the lamination of the rotor. Compression distortion, cupping and gaps may have a detrimental impact upon overall rotor function and are therefore undesirable.

It is desirable to provide assembly improvements that can minimize the undesirable impacts of pressing operations and improve motor performance.

### BRIEF DESCRIPTION OF THE INVENTION

Disclosed is a lamination for an electric machine rotor. The lamination includes a disc defining a center hole. Slots are defined in the disc. Each slot is configured to receive a magnet at least partially defining a magnetic pole of the electric machine. The center hole has a circumference including a number of scallops. Each scallop in the number of scallops intrudes into the disc.

Also disclosed is a rotor for an electric machine. The rotor includes a lamination stack including multiple laminations. Each lamination includes a disc defining a center hole. Slots are defined in the disc. Each slot is configured to receive a magnet at least partially defining a magnetic pole of the electric machine. The center hole has a circumference including a number of scallops. Each scallop in the number of scallops intrudes into the disc.

Also disclosed is an electric machine includes a rotor press fit to a knurled section of a shaft. The rotor includes a lamination stack having a multiple laminations. Each lamination includes a disc defining a center hole. Slots defined in the disc. Each slot is configured to receive a magnet at least partially defining a magnetic pole of the electric machine. The center hole has a circumference including a number of scallops. Each scallop intrudes into the disc. A stator is disposed radially outward of a rotor.

### BRIEF DESCRIPTION OF THE DRAWINGS

The following descriptions should not be considered limiting in any way. With reference to the accompanying drawings, like elements are numbered alike:

FIG. 1 depicts a schematic cross section of an electric machine including a laminated rotor stack;

FIG. 2 depicts a partial view of a rotor lamination on the shaft of the rotor stack of FIG. 1;

FIG. 3 depicts a single scallop feature of the rotor lamination of FIG. 2. and

FIG. 4 depicts a sectional side view of the shaft of FIGS. 1-3 prior to installation of the rotor laminations;

### DETAILED DESCRIPTION OF THE INVENTION

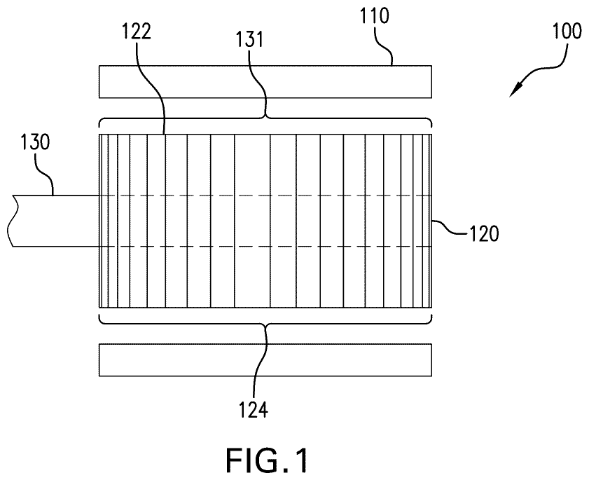

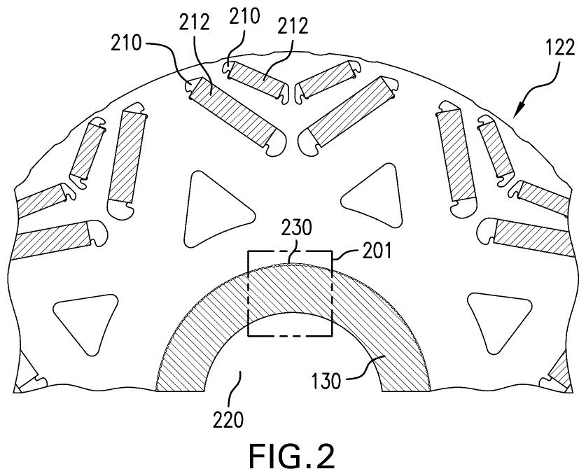

FIG. 1 illustrates a highly schematic traction motor 100, including a stator 110 disposed around a rotor 120. The rotor 120 is constructed of a set of multiple laminations 122 with each lamination 122 include multiple slots. A partial view of one example lamination 122 is illustrated in FIG. 2.

With reference to FIGS. 1 and 2, the laminations 122 are mounted to a shaft 130. Each lamination 122 includes multiple slots 210 receiving magnets 212 (e.g., permanent magnets). The magnets 212 define the rotor poles of the traction motor 100.

While in a motor mode of operations, interactions between an electromagnetic field generated by the stator 110 and the magnetic field of the magnets 212 drives the rotor 120 to rotate. As the rotor 120 is mechanically supported on, and fixed to, the shaft 130, rotation of the rotor 120 drives rotation of the shaft 130 and the rotation is output to any systems connected to the shaft 130. Operations of the traction motor 100 can be controlled using any control configuration according to existing principles.

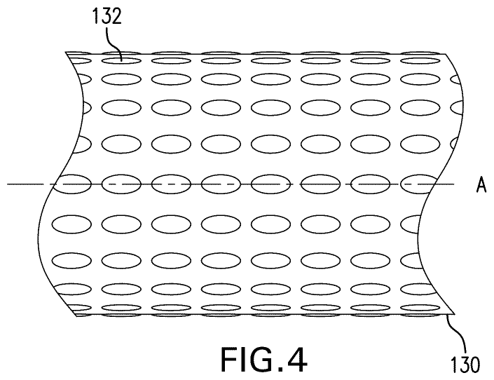

The combined set of laminations 122 are referred to as a lamination stack 124. To retain the lamination stack 124 on the shaft 130, the lamination stack 124 has a center hole 220 which is pressed onto the shaft 130. At a portion of the shaft 130 retaining the lamination stack 124, the shaft 130 is knurled. Knurls are small protuberances, or knobs, extending outward from an outer diameter of the shaft 130. An example knurling pattern is illustrated in FIG. 4, with multiple knurls 132 extending along a surface of the shaft 130 at a region of the shaft 130 where the lamination stack 124 is press fit into place. The knurls 132 are staggered so that multiple knurls are present at any given axial position on the shaft 130, relative to a shaft axis A. The axial staggering of the knurls 132 ensures that all lamination 122 installed in the knurled portion of the shaft contact multiple knurls 132 to maintain the press fit. In some examples, a knurled section 131 of the shaft 130 is at least as long as the lamination stack 124.

In alternative examples, the knurls 132 may include other geometries (e.g. diamond or trapezoid geometries). In some examples, all the knurls 132 are identical. In other examples, the knurls 132 may be formed using a combination of multiple geometries and sizes.

The laminations 122 are stacked together by either welding, interlocking or glueing to form the lamination stack 124. During assembly of the traction motor 100, the lamination stack 124 is press fit onto the shaft 130. When the circumference of the center hole 220 is circular, and the press fit and force is too high, the lamination stack 124 can become damaged. Similarly, if an incorrect size knurl 132 is used, the resulting lamination stack 124 can be loose in the finished assembly. In order to increase manufacturing efficiencies, standardized knurl dies may be used in some examples to create the knurls. When this is the case, the possibility of improper press fit and force is increased.

In order to reduce the possibility of a press fit and force requirement that is too high, and to increase the range of standardized knurl dies that may be used for a given lamination stack 124, each lamination 122 includes multiple scalloped features 230. The scalloped features are portions of the circumference of the center hole 220 that extend radially outward into the lamination 122 and away from a center of the center hole 220.

In one example, the scalloped features are elliptical in nature (i.e. form an arc that is a portion of an ellipsis). Using elliptical scallops for the scalloped feature minimizes the stress concentration on the inner circumference of the lamination stack 124 while providing the sufficient press fit to maintain the lamination stack 124 static relative to the shaft 130. In alternative examples, the scalloped features may include other geometries (e.g. diamond or trapezoid geometries). In some examples, all the scalloped features are identical in shape and dimension. In other examples, the scalloped features may be formed using a combination of multiple geometries and sizes.

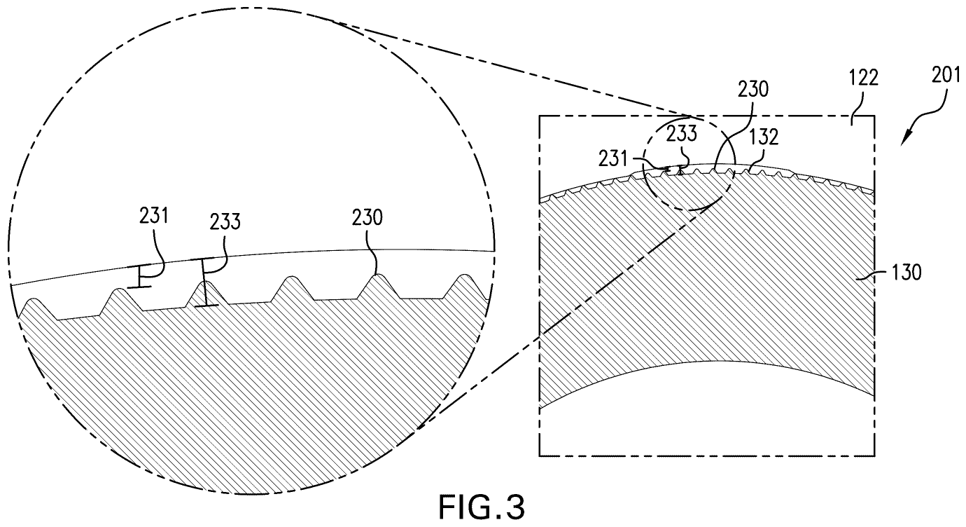

With continued reference to FIGS. 1-2, and FIG. 4, FIG. 3 illustrates a close up view of a section 201 of FIG. 2. The section 201 includes a single scallop 230 and illustrates a depth 231 from a radially outermost portion of the knurls 132 to the scallop 230 and a depth 233 from the shaft 130 to the scallop 230. Each scallop 230 is defined with a depth 233 of sufficient length that the depth 231 is greater than zero, when accounting for manufacturing tolerances. While illustrated in the examples as an arc shaped intrusion into the circumference of the center hole 220, it is appreciated that the scallops 230 may be achieved using alternative shapes. By way of example, in some alternatives the edges of each scallop may be defined by a straight edge aligned with a radius of the shaft 130 and the scallop will include an identical arc shape as the circumference of the center hole 220 at the position of the scallop 230.

Inclusion of the scallops 230 allows the interference fit between the center hole 220 of the lamination stack 124 and individual knurls 132 of the shaft 130 to be the same as a configuration without scallops 230, while at the same time minimizing the press force required to press the lamination stack 124 into place. This, in turn, allows for the utilization of a standard knurl tool to form the knurls 132 on the shaft without risking an increase in the chances of an improper press fit and force.

The scallops 230 function by allowing the lamination stack 124 to skip, or not make contact with, a percentage of the knurls 132 at any given axial position on the shaft 130. In some examples, the scallops 230 are sized to skip a number of knurls 132 in the range of 55%-65% of the knurls 132 at a given axial position. In other examples, the scallops 230 are sized to skip approximately 58% of the knurls 132 at a given axial position.

In some examples, the number of scallops 230 on each lamination 122 is a whole number multiple of the number of poles of the lamination 122. By way of example, if the lamination 122 defines a four pole machine, then the number of scallops 230 on each lamination 122 could be four, eight, twelve, sixteen, twenty, or any other multiple of four. In some specific implementations, the number of poles is equal to the number of scallops 230.

In some examples each lamination 122 in the lamination stack 124 includes the same number and size of scallops 230. In these examples, when the lamination stack 124 is assembled, the scallops 230 of each lamination 122 are aligned with the scallops 230 of each other lamination in the lamination stack 124, such that the scallops 230 of the entire lamination stack 124 are at the same radial positions.

In one specific implementation a four pole electrical machine is constructed using a lamination stack 124 having eight scallops 230 on the center hole 220. The shaft 130 has a total of two hundred and twenty four knurls 132 at each axial position. Each scallop 230 skips fourteen knurls 132 on the shaft 130 resulting in a total of one hundred and twelve knurls 132 skipped at each axial position of the shaft 130.

The term “about” is intended to include the degree of error associated with measurement of the particular quantity based upon the equipment available at the time of filing the application. For example, “about” can include a range of ±8% of a given value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A lamination for an electric machine rotor, the lamination comprising:
a disc defining a center hole;
slots defined in the disc, where each slot is configured to receive a magnet at least partially defining a magnetic pole of the electric machine; and
the center hole having a circumference including a number of scallops, each scallop in the number of scallops intruding into the disc.

2. The lamination of claim 1, wherein the number of scallops is a whole number multiple of the number of magnetic poles of the electric machine.

3. The lamination of claim 2, wherein the number of scallops is equal to the number of magnetic poles of the electric machine.

4. The lamination of claim 1, wherein a scallop in the number of scallops is elliptical.

5. A rotor for an electric machine, the rotor comprising:
a lamination stack including a plurality of laminations; and
wherein each lamination includes a disc defining a center hole, slots defined in the disc, where each slot is configured to receive a magnet at least partially defining a magnetic pole of the electric machine and the center hole having a circumference including a number of scallops, each scallop in the number of scallops intruding into the disc.

6. The rotor of claim 5, wherein each lamination includes a same number of scallops as each other lamination in the plurality of laminations.

7. The rotor of claim 6, wherein the scallops of each lamination are radially aligned with the scallops of each other lamination in the lamination stack.

8. The rotor of claim 5, wherein the number of scallops of each lamination is a whole number multiple of the number of magnetic poles of the electric machine.

9. The rotor of claim 8, wherein the number of scallops of each lamination is equal to the number of magnetic poles of the electric machine.

10. An electric machine comprising:
a rotor press fit to a knurled section of a shaft, the rotor including a lamination stack having a plurality of laminations, wherein each lamination includes a disc defining a center hole, slots defined in the disc, where each slot is configured to receive a magnet at least partially defining a magnetic pole of the electric machine and the center hole having a circumference including a number of scallops, each scallop in the number of scallops intruding into the disc; and
a stator disposed radially outward of a rotor.

11. The electric machine of claim 10, wherein the knurled section of the shaft includes shaped knurls protruding from an exterior surface of the shaft, and wherein each scallop skips a number of knurls at an axial position of the scallop.

12. The electric machine of claim 11, wherein a number of knurls skipped by each scallop is in a range of 55%-65% of a total number of knurls at the axial position of the scallop.

13. The electric machine of claim 11, wherein a number of knurls skipped by each scallop is approximately 58% of a total number of knurls at the axial position of the scallop.

14. The electric machine of claim 11, wherein the shaped knurls are evenly distributed about the shaft in the knurled section such that a number of knurls at each axial position in the knurled section is the same.

15. The electric machine of claim 11, wherein the knurled section of the shaft is at least as long as a total length of the plurality of laminations.

16. The electric machine of claim 10, wherein each scallop in the number of scallops is elliptical.

17. The electric machine of claim 10, wherein each lamination includes a same number of scallops as each other lamination in the plurality of laminations.

18. The electric machine of claim 17, wherein the scallops of each lamination stack are radially aligned with the scallops of each other lamination in the lamination stack.

19. The electric machine of claim 10, wherein the number of scallops of each lamination is a whole number multiple of the number of magnetic poles of the electric machine.

20. The electric machine of claim 19, wherein the number of scallops of each lamination is equal to the number of magnetic poles of the electric machine.
